(19) United States
(12) Patent Application Publication
(10) Pub. No.: US 2020/0031418 A1
(43) Pub. Date: Jan. 30, 2020

(54) Foot-controlled personal transportation device

(71) Applicants: Shane Chen, Camas, WA (US); Jennifer Lynn Chen, Camas, WA (US); Ywanne Ying Chen, Philadelphia, PA (US)

(72) Inventors: Shane Chen, Camas, WA (US); Jennifer Lynn Chen, Camas, WA (US); Ywanne Ying Chen, Philadelphia, PA (US)

(21) Appl. No.: 16/518,968

(22) Filed: Jul. 22, 2019

Related U.S. Application Data
(60) Provisional application No. 62/711,527, filed on Jul. 28, 2018.

(51) Int. Cl. B62K 11/00; B62D 51/02; A63C 17/01; B62K 3/00; B62K 1/00

(52) U.S. Cl. CPC B62K 11/007; B62D 51/02; B62K 1/00; B62K 3/002; A63C 17/01

(57) ABSTRACT

A foot-controlled personal transportation device having a drive wheel and a foot platform, with the drive wheel preferably located below the platform. Device driving may be controlled by a position sensor and a control circuit that drives the device toward auto-balancing. The device can be detachably coupled to various accessories to change or expand the function of the device. The device can also exist as a permanently attached drive unit in a complete non-auto-balancing vehicle such as a skateboard or scooter.

### CROSS REFERENCE TO RELATED APPLICATIONS

The present application claims the benefit of Provisional Application No. 62/711,527, filed Jul. 28, 2018, and entitled Foot-Controlled Personal Transportation Device, by the inventors above.

### FIELD OF THE INVENTION

The present invention relates to personal transportation devices and, more specifically, to such devices with under platform drive wheels and/or single-foot foot platforms, and expanded uses for such devices.

### BACKGROUND OF THE INVENTION

The prior art includes U.S. Pat. No. 8,738,278 issued to Shane Chen (the inventor herein) for a Two-Wheel, Self-Balancing Vehicle with Independently Movable Foot Placement Sections. This patent is hereby incorporated by reference as though disclosed in its entirety herein. The '278 patent teaches fore-aft self-balancing of two movable foot platforms, as well as drive motors, control circuitry, and related components.

In the '278 patent, the foot platforms are coupled to one another and although separately rotatable in fore-aft, they are maintained in a fixed parallel relationship. There is no independent movement laterally or longitudinally relative to one another.

U.S. patent application Ser. No. 15/916,985, by the inventor herein, teaches auto-balancing transportation devices that allow this lateral and/or longitudinal movement to one another. These devices can accommodate each foot separately and thus function as “single-foot” devices. These devices also have a low or smaller profile, including arranging the drive wheel under the foot platform, thereby creating platforms that may be mounted or dismounted without (or with very little) obstruction.

An auto-balancing device having separate single-foot foot platforms, and particularly one with the drive wheel under the foot platform, provides several benefits. These include accommodating riders of different size and foot spacing preference and enhancing the riding experience by allowing riders to freely move their legs and feet forward-backward and/or side-to-side. The independent foot movement also permits a rider to navigate around obstacles and through narrow pathways, and to encounter bumps in series (one after the other) rather than in parallel (both wheels at the same time) which is usually more stable.

Another benefit of two separate smaller units compared, for example, to the bulk of Hovertrax type devices and the even larger Segway type devices, is that the single-foot foot platform devices of the present invention are relatively small and lightweight. This makes them easy to carry or stow, for example, at work, on a bus, or at home. This latter benefit may be particularly important in making low profile single-foot devices a viable commuter option.

The '985 application describes embodiments having a cylindrical wheel structure with the entire width of the wheel contacting the ground. While the cylindrical wheel does not necessarily hinder steering when two devices are being used as a pair as taught by the '985 application, a single such device used alone would have difficulty turning. Although a cylindrical wheel provides lateral stability, the range of potential uses of the device could be expanded by making the wheel curved convexly from side to side, causing the wheel to naturally turn toward the side to which it is leaning

The '985 application describes embodiments having a foot platform symmetrical in the fore-aft direction such that the rider can stand facing either direction with no difference. Although this is useful for the convenience of stepping onto the device facing either direction, some riders may feel more comfortable standing on a platform which extends farther forward from the wheel than it does backward, to match the proportions of the human foot relative to the ankle joint.

The rising popularity of auto-balancing personal transportation devices is due in part to their simplicity of operation and ease of use. Since shifting body weight to initiate acceleration is part of the mechanics of human walking and running, many users find that operating auto-balancing vehicles feels natural and intuitive. Meanwhile, operating methods for electric skateboards and scooters in the prior art often lack the convenience and intuitiveness of auto-balancing devices. Auto-balancing single-axis skateboards exist but are a fundamentally different type of vehicle from conventional powered skateboards. A need exists for personal transportation devices which are not themselves auto-balancing but which have some of the advantages of auto-balancing drive methods.

### SUMMARY OF THE INVENTION

Accordingly, it is an object of the present invention to provide a single-foot foot-controlled personal transportation device with lean-to-turn capabilities.

It is also an object of the present invention to provide a single-foot foot platform personal transportation device with a directional foot platform.

It is another object of the present invention to apply auto-balancing drive methods to familiar types of personal vehicles such as skateboards and scooters, without making the vehicles themselves auto-balancing.

The attainment of the foregoing and related advantages and features of the invention should be more readily apparent to those skilled in the art, after review of the following more detailed description of the invention taken together with the drawings.

### BRIEF DESCRIPTION OF THE DRAWINGS

FIGS. 1-2 show perspective views of a pair of single-foot foot platform auto-balancing transportation devices in accordance with the present invention.

FIGS. 3-4 show perspective views of the device of FIGS. 1-2 with platform raised.

FIGS. 5-6 show perspective views of another embodiment of a foot-controlled personal transportation device according to the present invention.

FIGS. 7-9 show perspective, front, and side views of a foot-controlled personal transportation device according to the present invention.

FIG. 10 shows a perspective view of an embodiment of the present invention equipped with foot support accessories.

FIG. 11 shows a perspective view of an embodiment of a motor skateboard driven by the device of the present invention.

FIG. 12 shows a perspective view of another view of an embodiment of a motor skateboard driven by the device of the present invention.

FIG. 13 shows a perspective view of an embodiment of a motor scooter driven by the device of the present invention.

FIG. 14 shows a perspective view of another embodiment of a motor scooter driven by two units of the device of the present invention.

### DETAILED DESCRIPTION

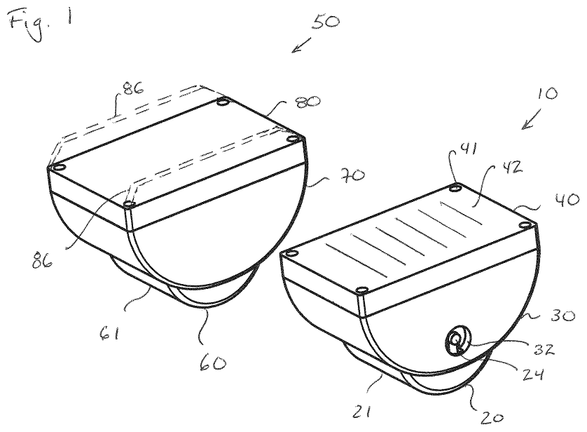

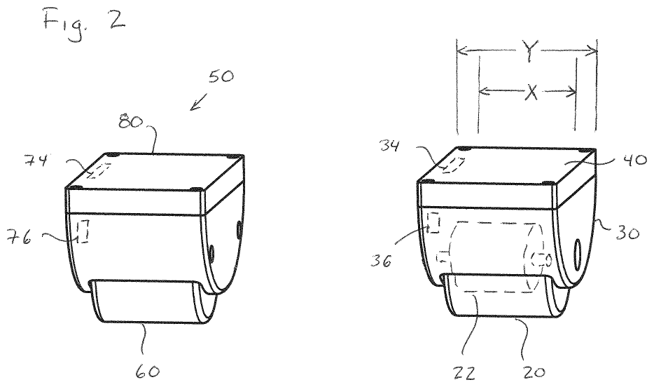

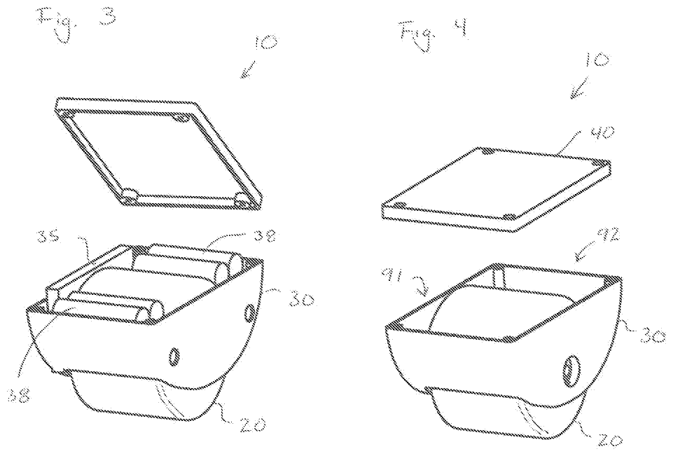

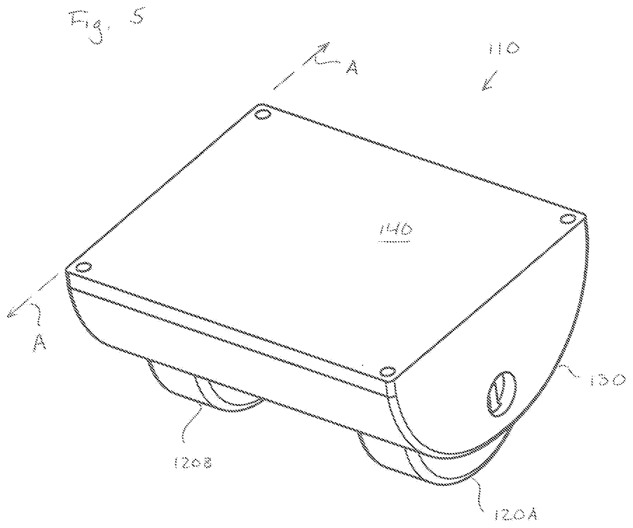

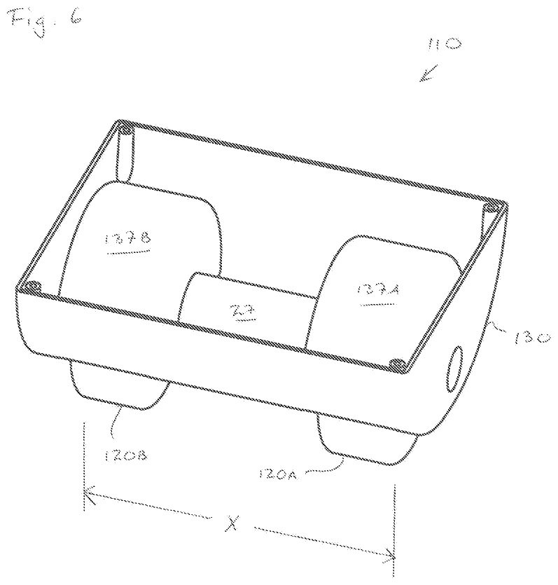

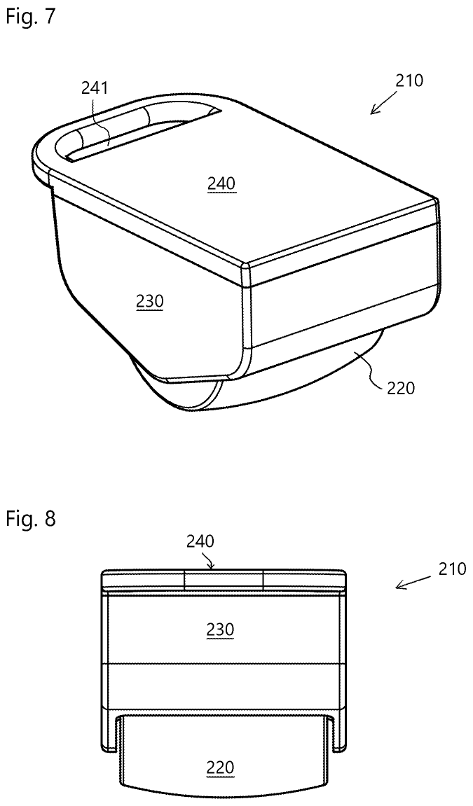

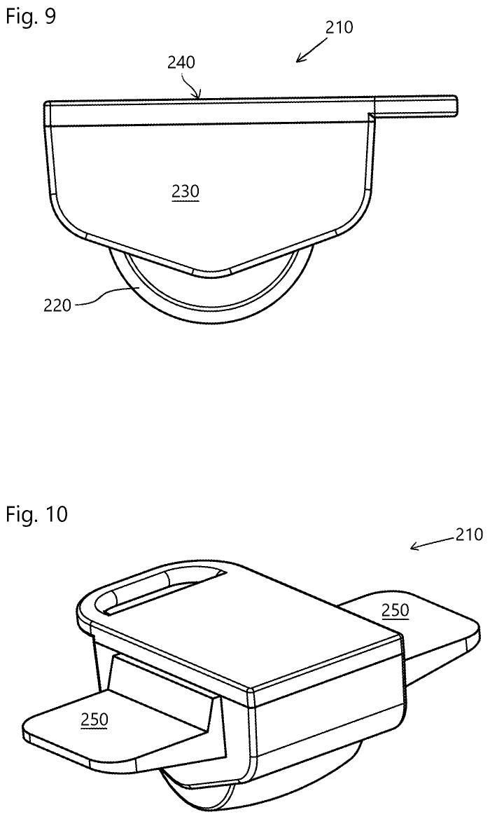

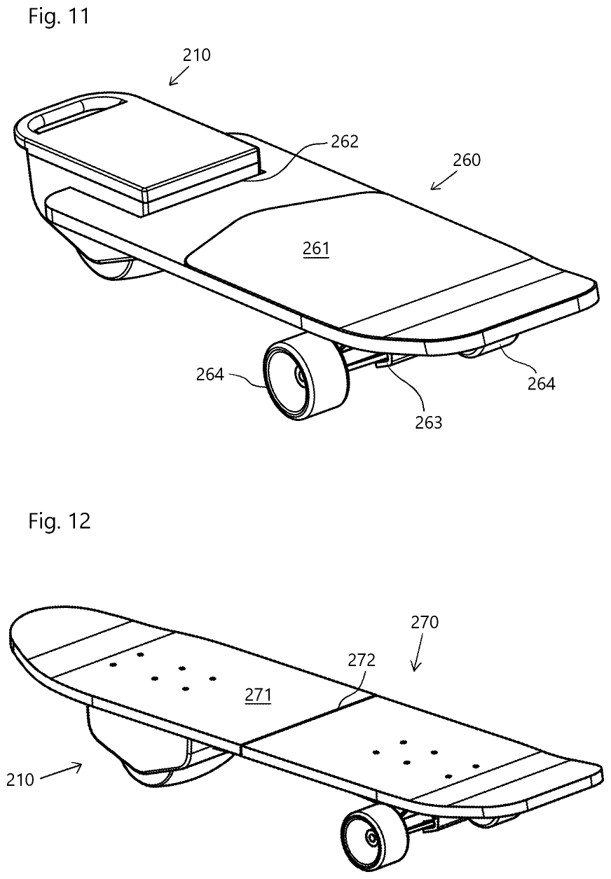

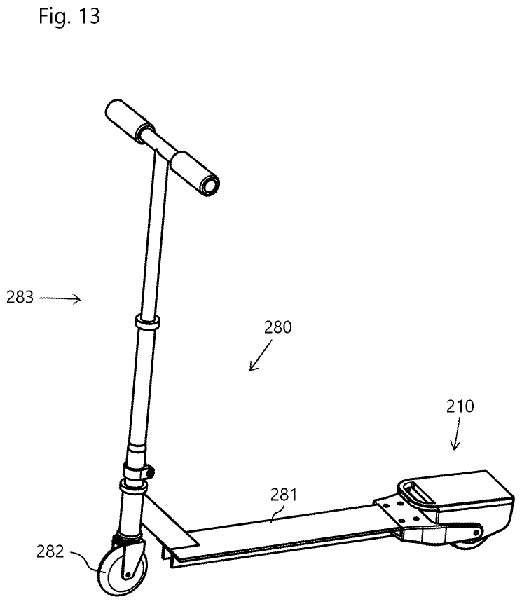

Referring to FIGS. 1-2, perspective views of a pair of single-foot foot platform auto-balancing transportation devices 10,50 in accordance with the present invention are shown. Devices 10,50 are substantially the same and may be used interchangeably (by the left or the right foot, and forward or backward). That said, paired single-foot foot platform devices within the present invention may be configured specifically for the left and right foot, similar to shoes, without departing from the present invention.

Device 10 preferably has a wheel 20, a casing 30 and a platform 40. Wheel 20 is preferably driven by a hub motor 22 (shown in phantom lines in FIG. 2). Motor 22 may have a pair of mounting rods 24 that couple to brackets 32 which are fixedly coupled to casing 30. In this manner, the motor and wheel are securely coupled to the casing. Mounting rods 24 are preferably arranged coaxially with the axis of rotation of wheel 20. Thus, in this embodiment, the axis of rotation of the motor and the wheel are the same. Wheel 20 may also include a tire or other exteriorly-disposed traction enhancing and/or shock absorbing material 21.

Foot platform 40 may be fastened by fasteners 41 to casing 30. A water-tight seal is preferably provided that protects the components internal to the platform and casing enclosure. Tread (rubber or other), grip tape (as used on skateboards) or other friction increasing material 42 may be applied to the top surface of platform 40.

Device 50 also preferably includes a wheel 60, a casing 70 and a platform 80. Wheel 60 may include a tire 61 or the like and is preferably driven by a similarly mounted hub motor. These and related components may be configured as their counterparts in device 10. FIG. 1 illustrates that sidewalls 86 may ascend from platform 80. Sidewalls may assist in device control by allowing a rider 20 to exert pressure on them with his or her foot. The sidewalls are illustrated in phantom lines because they are optional. While shown on only one device, they may be provided with any device herein. Also, they may have different shapes without deviating from the present invention. A low side wall, however, creates less obstruction for mounting or dismounting the device.

Device 10 preferably includes a position sensor 34, a control circuit 36, a battery 38 (shown in FIG. 3), and drive motor 22. Position sensor 34 is preferably a gyroscopic sensor. It is capable of sensing fore-aft pitch and may sense sideways tilt, among other measures. In response to a forward pitch angle, the device is driven forward and in response to a rearward pitch angle, it is driven in reverse. The speed is based on the magnitude of the pitch angle. Auto-balancing components and techniques are known in the art.

Device 50 similarly includes a position sensor 74, a control circuit 76, a battery 78 and a drive motor (obscured from view, but represented by drive motor 22). Device 50 operates in a manner similar to device 10.

Thus, devices 10,50 are effectively stand-alone auto balancing transportation devices. In the embodiments of FIGS. 1-2, the platforms may be 3-4″ wide (laterally) and 6-8″ long (longitudinally), or other.

Referring to FIGS. 3 and 4, perspective views of device 10 with platform 40 raised are shown. Since platform 40 extends longitudinally and casing 30 extends between wheel 20 and the edges of the platform, two volumes or cavities 91,92 are formed (FIG. 4), one each on opposite longitudinal sides of the wheel. A thin volume may also exist on the lateral sides of wheel 20 depending on the shape of the housing and the wheel.

Batteries 38 are preferably placed in one or both of volumes 91,92. A circuit board 35 may be placed in the thin cavity on a lateral side of wheel 20 (FIG. 3). Position sensor 34 and control circuit 36 are preferably placed on this circuit board. In this manner, the components of device 10 are efficiently arranged in the small available volume.

While two volumes 91,92 are shown formed by a single casing, it should be recognized that the components and casing could be otherwise arranged without departing from the present invention. For example, two separate casing sections could descend from the underside of the platforms. Further, as battery size decreases with advances in battery technology, the components and shape 10 of casing 30 may be otherwise arranged. With respect to casing 30, the shape of the casing may be otherwise arranged, regardless of decreases in battery size, without departing from the present invention. For example, the casing could be more tapered or fluted, or rounded longitudinally, or otherwise functionally or artistically rendered.

Device 50 is preferably arranged internally in the same manner as device 10.

Wheels 20,60 are preferably centered laterally (or substantially so) to enhance lateral balance and are generally wide to enhance lateral stability. FIG. 2 illustrates a wheel width of X and a foot platform width 25 of Y. Preferably X is 50-100% of Y, though it may be less than 50% or more than 100% (with an extension mounting bracket or split wheel structure or the like) without departing from the present invention. More preferably, X may be 60-95% of Y or 70-90% of Y.

Referring to FIGS. 5-6, perspective views of another embodiment of a foot-controlled personal transportation device 110 in accordance with the present invention are shown.

Similar to device 10, device 110 includes wheels 120A,120B, a casing 130 and a platform 140. Device 110 also preferably includes a sensor, control circuit and battery as discussed above. FIG. 5 illustrates device 110 with the platform on and FIG. 6 with the platform removed.

In contrast to the single wheel of device 10, device 110 includes two wheels 120A,120B. These wheels are preferably coupled together by an axle shaft or the like within casing section 127 such that if one wheel turns, the other does as well. A hub motor is preferably provided with wheel 120A and thus as wheel 120A is driven, so is wheel 120B. A non-hub motor (or a modified hub motor) may also be used, and it may be placed between the wheels. This motor may be axially arranged or other.

The term “single wheel structure” is used herein to refer to a single wheel such as wheel 20 of FIG. 1 and to a paired or multiple coupled wheels where movement among the wheels is the same, such as with coupled wheels 120A,120B (i.e., the wheels function as a single wide wheel).

The coupled wheels of FIG. 5 allow for a wide overall wheel width, X, from the outside edge of one wheel to the outside edge of the other. A wide X provides enhanced lateral stability.

The dimensions of device 110 may be larger than those of device 10. In device 110, as shown, the width of the device may be wider than long. This would allow a rider to stand with both feet on platform 140, likely facing forward. Platform 140 may also be extended longitudinally in the directions of Arrows A. Extending the platform in this dimension would allow a rider to stand comfortably, sideways, with both feet on platform 140, or to stand somewhere in between straight-forward and sideways. Hence, it is possible to configure the present invention for riding with a single foot or both feet. Furthermore, for example, if platform 140 is extended in direction A and overhangs casing 130, then a handle (formed by an opening in the overhanging portion) could readily be formed in the platform making the device easy to pick up, carry and put down.

While wheels 120A,120B were described above as part of a single wheel structure and driven by a single motor, it should be recognized that those wheels could be driven by separate motors and at different speeds. For example, they may be arranged coaxially, yet without a common axle, and pressure sensors may be provided on platform 140 in addition to the position sensor within the device. The position sensor could detect fore-aft pitch for general driving, and the pressure sensors could detect lateral weight shift and afford turning by adjusting the speed of each wheel (based on weight distribution) to affect a turn.

FIGS. 7-9 show another embodiment of a transportation device 210 in accordance with the present invention. Similar to device 10, this device includes a wheel 220, a casing 230, and a platform 240. Device 210 also preferably includes a sensor, control circuit, and battery, as described in the previous embodiments. The ground-contacting surfaces of wheel 220 may be convexly curved from side to side, with the greatest circumference being in the center, such that when wheel 220 is standing vertically, its left and right edges do not touch the ground. When device 210 tilts to one side, the portion of wheel 220 in contact with the ground shifts toward the side of the tilt, and the differential circumference in the ground-contacting areas of wheel 220 causes device 210 to turn toward the direction of the tilt. Thus, the curved wheel enhances turning, which facilitates rider control of steering and aids in balance during travel. Having less area of the wheel in contact with the ground also reduces frictional resistance to turning. To ensure stability and support for the rider's feet, the side-to-side curvature of wheel 220 is an arc of a virtual circle or ellipse centered at a height greater than the height of platform 240. In other embodiments, the virtual circle or ellipse may be even larger for additional stability and comfort, at the expense of having a larger turning radius. For instance, the height of the center of the virtual circle or ellipse may be greater than the height of a rider's ankle, or greater than the height of a rider's center of mass.

Another feature of device 210 is a directional platform. Whereas the previous embodiments have platforms which are symmetrical in the front-back dimension so that the rider can face either direction when standing on the device, platform 240 extends farther past the wheel in one direction than in the other direction. The longer end of platform 240 is designated as forward. This directional design allows a more comfortable and natural stance for the rider by considering the proportions and mechanics of the human foot and ankle, whereas a symmetrical design may cause fatigue in the rider's legs and ankles. A recess or cutout 241 may be provided in the front or back of platform 240 for use as a carrying handle. Any embodiment of the devices of the present invention can include a directional casing and platform.

FIGS. 10-14 show device 210 equipped with a variety of attached elements. These and other accessories can be removably and interchangeably coupled to the device to allow for different riding stances, to alter or enhance the device's features, or to use the device as a drive and control module for various forms of vehicles. Device 210 may have at least one point of attachment to which accessories may be coupled. Each point of attachment may be interchangeably couplable with multiple accessories, providing a common location and method of coupling, and enabling the accessories to be easily swapped by the user. The point or points of attachment may be in line with the wheel's rotational axis. Device 210 may be provided with different software modes adapted for different accessories, and may automatically detect which accessory is currently equipped and switch to the appropriate software mode. The detection can be achieved mechanically or electronically. An electronic coupling can also be used for other functions, such as to power and control functional or decorative lights on the accessories, among other possibilities.

FIG. 10 shows device 210 equipped with left and right foot support members 250 coupled to the sides of device 210. Other embodiments of this accessory may have both foot support members formed as one piece, instead of as two separate members. Foot support members 250 extend laterally from the sides of device 210 and can support a rider's feet, allowing the rider to use a single device as a complete two-foot vehicle. Since the device ridden in this manner must be tilted to one side in order for the rider to mount one foot at a time, the software mode associated with the foot support accessories may include mounting and dismounting modes wherein balancing functions are suspended while the device is leaning past a certain angle, possibly also factoring in other conditions such as speed of travel, presence of the rider, or yaw.

FIG. 11 shows device 210 equipped with a skateboard accessory 260, comprising a board 261 whose rear half is supported by a skateboard truck 263 with two wheels 264. The front of board 261 has a recess 262 which receives and pivotably couples to device 210. The user stands with one foot on board 261 as on a conventional skateboard, and one foot on device 210. The rider can control the acceleration and deceleration of the skateboard by using their front foot to tilt device 210 forward and backward. The rear foot can control turning by tilting board 261 laterally, in a manner similar to that of a conventional skateboard.

FIG. 12 shows device 210 equipped with another embodiment of a skateboard accessory 270 having a board 271. This skateboard accessory differs from skateboard accessory 260 of FIG. 11 in that board 271 is shaped like a conventional skateboard, and the front of board 271 is supported on top of device 210. Board 271 has a joint 272 which allows the front portion and the rear portion of board 271 to tilt in the fore-aft dimension relative to each other, allowing device 210 to tilt forward and backward. The operation of device 210 and skateboard accessory 270 is similar to that described for the device of FIG. 11.

The combined device and skateboard accessory may alternatively be non-detachably coupled as a complete electric skateboard using an auto-balancing drive unit as its drive method. Since the drive unit is a permanent component of the skateboard, the battery and/or the control circuit need not be within or adjacent to the drive unit, and can be located anywhere in or on the skateboard.

FIG. 13 shows device 210 equipped with a scooter accessory 280. The scooter accessory comprises a longitudinally oriented standing surface 281, a front wheel 282, and a handle structure 283 which can be used to control the steering of wheel 282, in the style of a conventional kick scooter. Device 210 pivotably couples to the rear of standing surface 281, replacing the rear wheel of a conventional kick scooter. The user stands with one foot on standing surface 281 and the other foot on device 210 such that device 210 can be used to drive the combined device and scooter vehicle.

The combined device and scooter accessory may alternatively be non-detachably coupled as a complete electric scooter using an auto-balancing drive unit as its drive method. Since the drive unit is a permanent component of the scooter, the battery and/or the control circuit need not be within or adjacent to the drive unit, and can be located anywhere in or on the scooter.

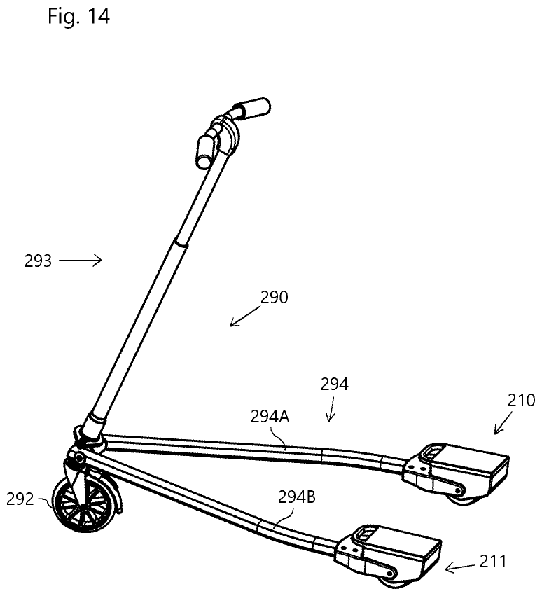

FIG. 14 shows two units of device 210, 211 equipped with another scooter accessory 290. The scooter accessory comprises a handle structure 293 which can be used to control the steering of a front wheel 292, and a frame structure 294, in this embodiment comprising left frame member 294A and right frame member 294B, which extend rearwardly from handle structure 293. Device 210 pivotably couples to the rear of left frame member 294A, and device 211 pivotably couples to the rear end of right frame member 294B. Front wheel 292 may be a caster.

The combined device and scooter accessory may alternatively be non-detachably coupled as a complete electric scooter vehicle using an auto-balancing drive unit as its drive method. Since the drive unit is a permanent component of the scooter, the battery and/or the control circuit need not be within or adjacent to the drive unit, and can be located anywhere in or on the scooter.

It should be recognized that while auto-balancing is a preferred technique for these devices, devices may use pressure sensors or torsion sensors or other sensors, individually or in various combinations, without departing from the drive wheel under foot platform, single-foot foot platform, and/or other inventive aspects of the present invention. While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A transportation device, comprising:
a foot platform;
a wheel structure located below the foot platform;
a motor that drives the wheel structure;
a sensor;
a control circuit that drives the motor based on data from the sensor; and
at least one point of attachment to which at least one accessory can be selectively and interchangeably coupled.

2. The device of claim 1, wherein the circumference of the wheel structure at its midline is greater than the circumference of the wheel structure at its left and right edges.

3. The device of claim 1, wherein the foot platform extends past the wheel structure farther in one longitudinal direction than in the other longitudinal direction.

4. The device of claim 1, wherein the foot platform has a cutout of suitable size and shape for use as a carrying handle.

5. The device of claim 1, wherein the foot platform has a recess in its underside of suitable size and shape for use as a carrying handle.

6. The device of claim 1, wherein the at least one point of attachment is in line with the wheel's rotational axis.

7. The device of claim 1, wherein the accessory comprises a left foot support member and a right foot support member rigidly coupled to the sides of the device such that a rider can stand on the foot support members instead of or in addition to on the device's platform.

8. The device of claim 1, wherein the accessory comprises a longitudinally oriented board for supporting a human rider, and two wheel structures for supporting the end of the board not coupled to the device, such that the device can be controlled by one of the rider's feet to drive the combined device and accessory.

9. The device of claim 1, wherein the accessory comprises:
a platform for supporting a standing human rider;
at least one wheel structure coupled at or near one end of the platform; and
a handle structure for controlling steering of the accessory's wheel structure;
wherein the device can be controlled by one of the rider's feet to drive the combined device and accessory.

10. The device of claim 1, wherein an accessory for use with two devices comprises:
at least one frame member;
at least one front wheel structure coupled to the at least one frame member; and
a handle structure for controlling steering of the front wheel structure;
wherein the two devices can be controlled by the rider's feet to drive the combined device and accessory.

13. A powered skateboard device comprising:
a board for supporting a human rider;
a skateboard truck coupled to the board; and
an auto-balancing drive unit coupled to the board for driving the skateboard device, the drive unit being capable of tilting in the fore-aft dimension relative to the truck;
wherein the drive unit can be controlled by one of the rider's feet to drive the skateboard device.

14. The powered skateboard device of claim 13, wherein the drive unit is detachable and can be used as a stand-alone device or in combination with other devices or accessories.

15. A powered scooter device comprising:
at least one frame member;
at least one front wheel structure coupled at or near the front of the at least one frame member;
a handle structure which the rider can grasp for steering the front wheel structure; and
at least one auto-balancing drive unit coupled to the at least one frame member for driving the scooter device, the at least one drive unit being auto-balancing and capable of tilting in the fore-aft dimension relative to the front wheel structure;
wherein the at least one drive unit can be controlled by at least one of the rider's feet to drive the scooter device.

16. The scooter device of claim 15, further comprising a platform for supporting a human rider, and having a single drive unit.

17. The scooter device of claim 15, having a first drive unit controlled by the rider's left foot and a second drive unit controlled by the rider's right foot.

18. The scooter device of claim 15, wherein the at least one drive unit is detachable and can be used as a stand-alone device or in combination with other devices or accessories.
